(19) United States
(12) Patent Application Publication
(10) Pub. No.: US 2024/0362524 A1
(43) Pub. Date: Oct. 31, 2024

(54) Cluster Aware Power Management to Optimize Overall System Power to Maintain Compliant Thermal State

(71) Applicant: Dell Products L.P., Round Rock, TX (US)

(72) Inventors: Rishi Mukherjee, Bangalore (IN); Ravishankar N, Bangalore (IN); Sivakumar Swamy, Bangalore (IN)

(73) Assignee: Dell Products L.P., Round Rock, TX (US)

(21) Appl. No.: 18/140,750

(22) Filed: Apr. 28, 2023

(51) Int. Cl. G06N 20/00

(52) U.S. Cl. CPC G06N 20/00

(57) ABSTRACT

A system, method, and computer-readable medium for optimizing overall edge datacenter power and maintaining a compliant thermal state of edge devices in a cluster. Thermal compliant policy of the edge devices as to lower and upper limits is determined. Telemetry attributes from the edge devices are applied to a machine learning (ML) model to predict thermal condition of the edge devices over time. Workload is offloaded from one edge device to another edge device if predicted thermal condition of one of the edge devices is not within the limits of the thermal compliant policy.

### BACKGROUND OF THE INVENTION

### Field of the Invention

The present invention relates to edge device datacenters. More specifically, embodiments of the invention provide a system, method, and computer-readable medium for optimizing overall datacenter power and maintaining a compliant thermal state.

### Description of the Related Art

As more companies/enterprises require networks that can process data near the source, the use of edge computing is increasing. By deploying data centers and servers near the point of transmission, edge computing allows companies/enterprise to provide support and integrate technologies without increasing network congestion and latency.

Industries that generate data can benefit from the speed, scale and performance offered by edge computing. The increased use of internet of things (IoT), smart devices and evolving mobile networks has provided increase use of edge computing. An IoT-connected environment can generate massive volumes of data.

A datacenter can employ edge computing, or what can be referred to as an edge data center. The edge datacenter includes multiple edge devices, such as network servers, routers, storage devices, firewalls, IoT gateway devices, etc.

Edge devices may be located in physical operating environments that are relatively cool. Edge devices operate or may be required to operate at a certain minimal temperature. For example, the American Society of Heating, Refrigerating and Air-Conditioning Engineers (ASHRAE) standard defines temperature ranges for datacenter (i.e., edge datacenter) equipment (i.e., edge devices). To achieve and maintain a minimum operating temperature, an edge device can include a heater element. The heater element consumes power. Power consumption can be considerable, especially with multiple edge devices in an edge datacenter.

Edge computing continues to move towards full autonomy. With edge computing already transforming the way data is being handled, processed, and delivered, edge site operations are becoming as hands-off as possible. It is desirable to provide edge datacenter autonomy, ensure that the edge datacenter is fully operative, and meet temperature limits of edge devices while optimizing overall power consumption.

### SUMMARY OF THE INVENTION

A computer-implementable method, system and computer-readable storage medium for optimizing overall edge datacenter power and maintaining a compliant thermal state of edge devices comprising-determining a thermal compliant policy of the edge devices in a cluster; —receiving telemetry attributes of the edge devices of the cluster; applying a machine learning (ML) model using the telemetry to predict thermal condition of the edge devices over time; and —offloading workload from one edge device to another edge device if predicted thermal condition of one of the edge devices is not within the limits of the thermal compliant policy.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a general illustration of a system for implementing the processes of the described invention.

FIG. 2 is an example of a machine language (ML) model implementing processes of the described invention;

FIG. 3 is another example of a machine language (ML) model implementing processes of the described invention;

FIG. 4 is a generalized flowchart of an algorithm to offload workload of nodes/edges devices in a cluster to meet thermal compliance;

FIG. 5 is a generalized flowchart for optimizing overall edge datacenter power and maintaining a compliant thermal state of edge devices; and

FIG. 6 is a generalized illustration of an information handling system that can be used to implement the system and method of the present invention.

### DETAILED DESCRIPTION

Described herein are implementations that provide for a non-intrusive mechanism of identifying whether edge device temperature recommendations are maintained. Deviations as to lower and upper limits are autonomously maintained to keep the edge devices within the limits. In particular, workloads across edge devices in a cluster are moved, such that an edge device consumes optimal energy to maintain the temperature limits. Workloads to be moved are based by characterizing workloads on thermal output.

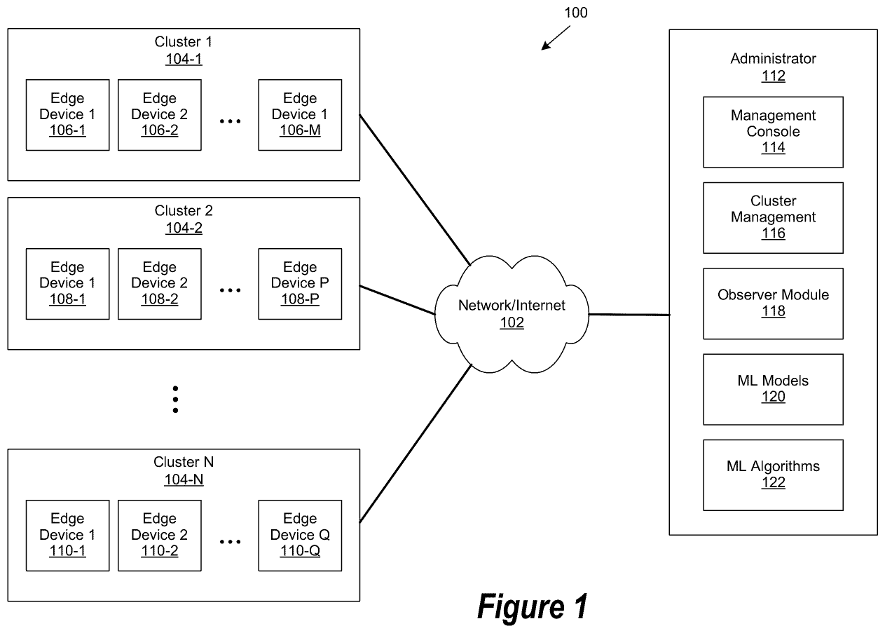

FIG. 1 shows a system 100 for implementing the processes of the described invention. The system 100 can be representative of an edge datacenter. In particular, system 100 provides optimizing overall edge datacenter power and maintaining compliant thermal state for the edge devices. The system includes a network 102, where network 102 can include one or more wired and wireless networks, including the Internet. Network 102 is likewise accessible by the elements of system 100.

The system 100 includes one or more clusters 104-1 to 104-N. Each cluster includes connected edge devices. Edge devices can be referred to as nodes of a cluster 104. Edge devices can be configured as information handling systems, and include network servers, routers, storage devices, firewalls, IoT gateway devices, etc. Each edge device is implemented with a heating element to assure thermal compliance. If an edge device goes below a lower limit temperature range, the heater element is powered to provide the necessary heat to bring the edge device into compliance. The thermal compliance can be set by industry standards, such as that defined by the American Society of Heating, Refrigerating and Air-Conditioning Engineers (ASHRAE).

Cluster 1 104-1 includes edge devices 106-1 to 106-M, cluster 2 104-2 includes edge devices 108-1 to 108-M, and cluster 104-N includes edge devices 110-1 to 110-Q. Clusters 104 can be defined by edge device functionality. In other words, edge devices 106 perform the same/similar function, edge devices 108 perform the same/similar function, and edge devices 110 perform the same/similar function. In certain implementations, clustering is based on particular software solution, such as VMWare®, Microsoft®, etc.

An administrator 112 of the system 100 (i.e., edge datacenter) controls and manages the clusters 104. Implementations provide for the administrator to configured as an information handling system. The administrator 112 includes a management console 114. The management console 114 can be configured as a user interface, and receive information/data from the components of the administrator 112.

Implementations provide for the administrator to include a cluster management component 116. The administrator 112 can be enabled to receive temperatures and temperature variances from the edge devices of clusters 104. Implementations provide for a baseband management controller or BMC (not shown) included in administrator 112 to receive such temperatures and temperature variances.

The cluster management component 116 is connected to the management console 114, and receives the temperature variances and can perform workload migration. Workload migration provides offloading the workload from one node/edge device to another node/edge device. This workload migration is performed for the different clusters 104. As further discussed herein, workload migration is based on the temperature variances of the nodes/edge devices of the clusters 104.

Implementations provide for either management console 114 to include policies as to thermal compliance and temperatures in which nodes/edge devices are to operate in. Various implementations provide for management console 114 implement the policies on the clusters 104 and their respective nodes/edge devices. The cluster management component 116 can be configured to manage and control the nodes/edge devices.

Implementations provide for the administrator 112 to an include an observer module 118. The observer module 118 connects to and receives telemetry attributes of the clusters 104 (i.e., nodes/edge devices). The observer module 118 can be connected to the clusters 104 (i.e., nodes/edge devices) via an application program interface (API). Telemetry attributes or data points are used to build machine language (ML) models which are further described herein. In particular, workloads of the clusters 104 can be classified based on the telemetry attributes or data points.

Examples of telemetry attributes or data points include CPU usage with a range of low, medium and high; memory usage with a range of low, medium and high; disk usage with a range of low, medium and high; network usage with a range of low, medium and high; power usage; and operating temperatures, inlet and outlet. Workloads can be classified as short, medium, and long based on their duration.

The administrator 112 includes the ML models 120 which use the telemetry attributes or data points. Examples ML models 120 are further described herein. The administrator also includes algorithms 122 to perform workload migration of the clusters 104 (i.e., nodes/edge devices).

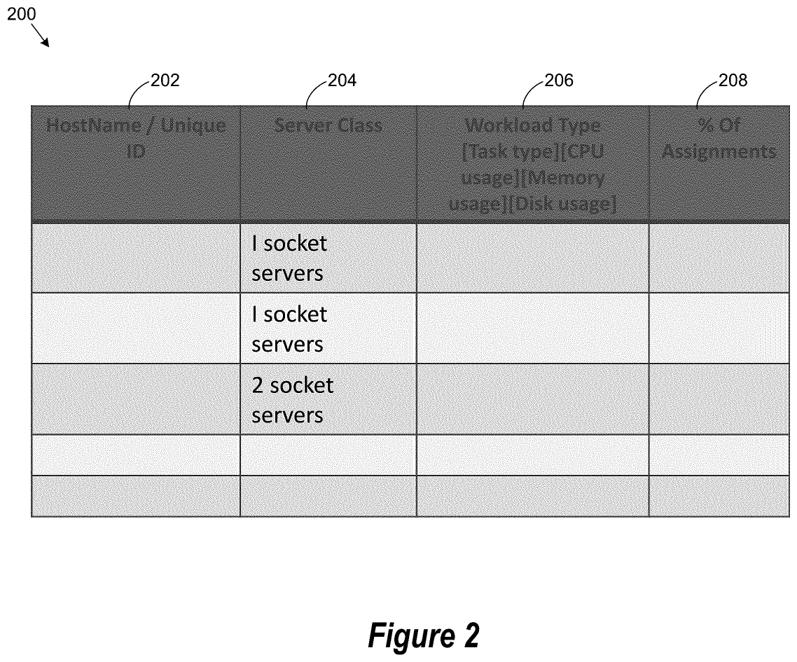

FIG. 2 is an example of a machine language (ML) model 200 implementing processes of the described invention. As discussed, ML models can be built based on telemetry attributes or data points that are gathered from the clusters 104 (i.e., nodes/edge devices). In ML model 200, nodes/edge devices of a cluster are identified by host name/unique ID 202, server class 204, workload type 206, and percentage of assignments 208. Based on server class 204 and workload type 206, the nodes/edge devices are assigned a percentage of assignments.

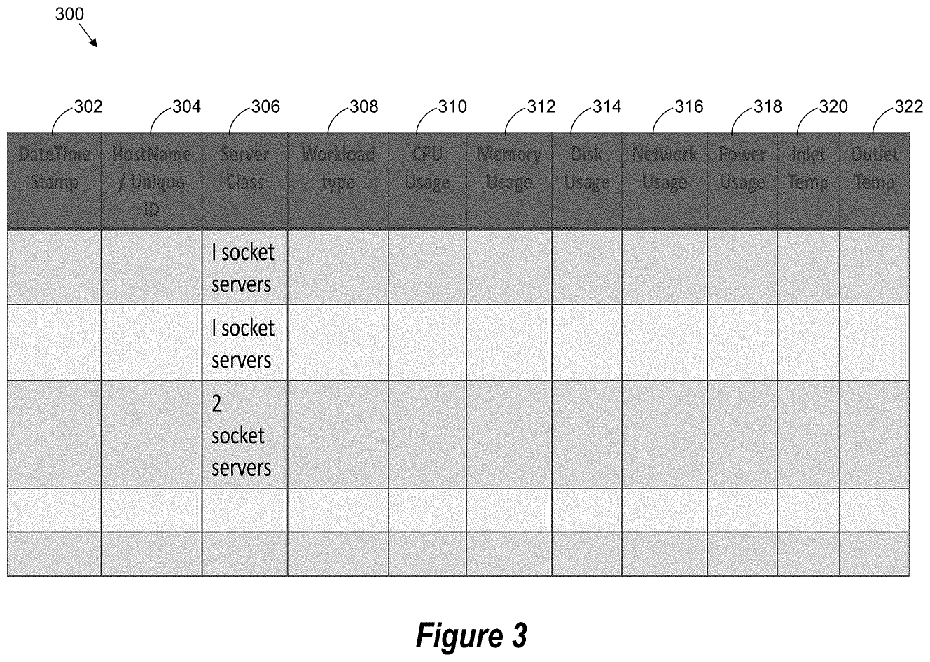

FIG. 3 is another example of an ML model 300 implementing processes of the described invention. In ML model 300, nodes/edge devices of a cluster are identified by a date time stamp 302, host name/unique ID 304, server class 306, workload type 308, CPU usage 310, memory usage 312, disk usage 314, network usage 316, power usage 318, inlet temperature 320, and outlet temperature 322. For ML model 300 actual telemetry attributes or datapoints are used, as well as actual power consumption.

Implementations provide for the ML models 120 to be applied with ML algorithms 122 for workload classification and characterization. Example of ML algorithms include K-means clustering, support vector machine (SVM), K-nearest neighbors (KNN), stochastic gradient descent (SGD), logistic regression (LR), decision tree (DT), random forest (RF), and multi-layer perceptrons (MLP).

In certain implementations, such as for ML model 300 for a telemetry dataset, telemetry attributes such as CPU usage, memory usage, and disk usage of different tasks can be normalized using min-max normalization to bring reduce the number of datapoints and bring them in the same range, achieving greater efficiency.

After normalization, a K-Means algorithm can be applied on individual telemetry attributes to determine the value of K corresponding to each telemetry attribute workload distribution in the telemetry dataset.

For example, for an ML model to predict node specific thermal condition, univariate time series data as described in ML model 300 is reference to a long short-term memory (LSTM) algorithm which is considered as part of the category of artificial recurrent neural networks (RNN).

The telemetry attributes contributing to operational thermal conditions are considered as inputs “X,” where X→[CPU Usage, memory usage, disk usage, network usage, power Usage]. The outputs “Y” constitute operational thermal condition, where the outputs, where Y→[inlet temp, outlet temp]. Using the telemetry attributes as defined as input and output sets, the ML Model can be trained to yield an expected prediction to identify the workload in a time instance that will meet the recommended thermal threshold.

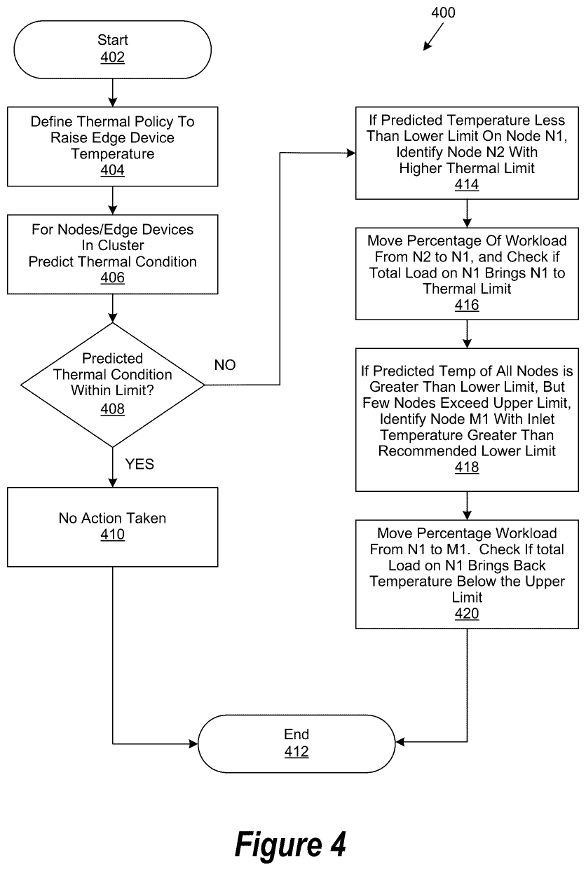

FIG. 4 is a generalized flowchart 400 of an algorithm to offload workload of nodes/edges devices in a cluster to meet thermal compliance. The order in which the algorithm is described is not intended to be construed as a limitation, and any number of the described method steps may be combined in any order to implement the algorithm, or alternate algorithm. Additionally, individual steps may be deleted from the algorithm without departing from the spirit and scope of the subject matter described herein. Furthermore, the algorithm may be implemented in any suitable hardware, software, firmware, or a combination thereof, without departing from the scope of the invention.

At step 402, the process 400 starts. At step 404, defining is performed as to thermal compliant policy to raise an event, such as offload workload of nodes/edge devices in a cluster if the thermal compliant policy is violated.

At step 406, for all the nodes/edge devices in the cluster, thermal condition is predicted by an ML model. The following steps are performed based on the prediction.

At step 408, a determination is performed as to whether thermal condition. Following action will be executed based on the thermal (temperature) prediction is within thermal condition limits of the thermal compliant policy.

If the thermal (temperature) prediction is within thermal condition limits, following the “YES” branch of step 408, at step 410, no action is taken/required. At step 412, the process 400 ends.

If the thermal (temperature) prediction is not within thermal condition limits, the process 400 follows the “No” branch of step 408. At step 414, If the predicted temp is less than the thermal compliant policy lower limit on a node/edge device “N1”, a node/edge device “N2” is identified which has a higher thermal limit, but does not thermal compliant policy upper limit.

At step 416, a percentage is moved/offloaded of the workload from node/edge device “N2” to node/edge device “N1.” A check is performed to determine if the total load on node/edge device “N1” will bring back node/edge device “N1” to the thermal compliant policy lower limit. The amount of workload that will be migrated from node/edge device “N2” is determined by an average thermal characteristics of the cluster as defined in the thermal compliant policy.

At step 418, if the thermal (temperature) prediction of all the nodes/edge devices is greater than the lower limit of thermal compliant policy, but a few nodes/edge devices exceed the upper limit of the thermal compliant policy, a node “M1” is identified which has an inlet temperature that is greater than the lower limit of the thermal compliant policy.

At step 420, a percentage is moved/offloaded of the workload from node/edge device “N1” to node/edge device “M1.” A check is performed to determine if the total load on node/edge device “N1” will bring back node/edge device “N1” below the upper limit of the thermal compliant policy. The amount of workload that will be migrated from node/edge device “N1” to node/edge device “M1” will be determined by average thermal characteristics of the cluster as defined in the thermal compliant policy. At step 412, the process 400 ends.

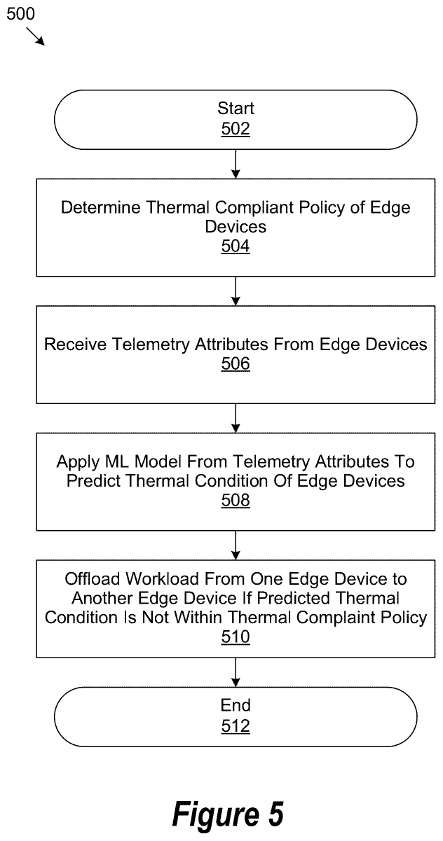

FIG. 5 is a generalized flowchart 500 for optimizing overall edge datacenter power and maintaining a compliant thermal state of edge devices. The order in which the method is described is not intended to be construed as a limitation, and any number of the described method steps may be combined in any order to implement the method, or alternate method. Additionally, individual steps may be deleted from the method without departing from the spirit and scope of the subject matter described herein. Furthermore, the method may be implemented in any suitable hardware, software, firmware, or a combination thereof, without departing from the scope of the invention.

At step 502, the process 500 starts. At step 504, a determination is performed as to thermal compliant policy of edge devices in a cluster. The thermal compliant policy can be set by an industry standard, such as the American Society of Heating, Refrigerating and Air-Conditioning Engineers (ASHRAE).

At step 506, telemetry attributes or data points of the edge devices of the cluster are received. Telemetry attributes can include CPU usage with a range of low, medium and high; memory usage with a range of low, medium and high; disk usage with a range of low, medium and high; network usage with a range of low, medium and high; power usage; and operating temperatures, inlet and outlet.

At step 508, an ML model is applied using the telemetry attributes or data points to predict thermal condition of the edge devices over time. Different ML algorithms can be applied to the ML model.

At step 510, workload offload is performed from one edge device to another edge device if predicted thermal condition of an edge device is not within limits set by the thermal compliant policy. At step 512, the process 500 ends.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a microphone, keyboard, a video display, a mouse, etc. The information handling system may also include one or more buses operable to transmit communications between the various hardware components.

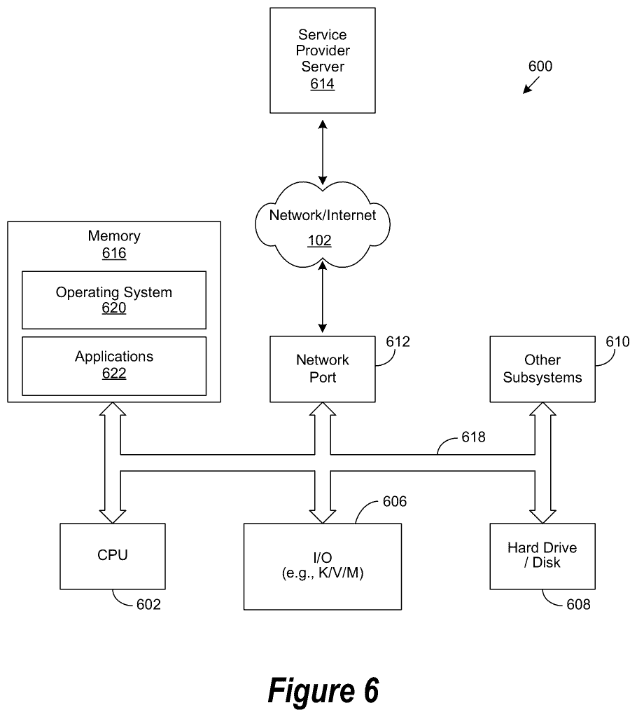

FIG. 6 is a generalized illustration of an information handling system 600 that can be used to implement the system and method of the present invention. The information handling system 600 can be configured for example as a laptop computer, desktop computer, network server, edge device, etc. In particular, the edge devices 106, 108, and 110 as described in FIG. 1 can be implemented as information handling system 600. Furthermore, administrator 112 as described in FIG. 1 can be implemented as information handling system 600.

The information handling system 600 includes a processor (e.g., central processor unit or “CPU”) 602, input/output (I/O) devices 604, such as a microphone, a keyboard, a video/display, a mouse, and associated controllers (e.g., K/V/M).

The information handling system 600 includes a hard drive or disk storage 608, and various other subsystems 610. In various embodiments, the information handling system 100 also includes network port 612 operable to connect to the network 102 as described in FIG. 1. As discussed, network 102 can include one or more wired and wireless networks, including the Internet. Network 102 is likewise accessible by a service provider server 614.

The information handling system 600 likewise includes system memory 616, which is interconnected to the foregoing via one or more buses 618. System memory 616 can be implemented as hardware, firmware, software, or a combination of such. System memory 616 further includes an operating system (OS) 620. Embodiments provide for the system memory 616 to include applications 622. Various implementations provide management console 114, cluster management 116, observer module 118, ML models 120, and ML Algorithms 122 to be included in system memory 616.

As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object-oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only and are not exhaustive of the scope of the invention.

Skilled practitioners of the art will recognize that many such embodiments are possible, and the foregoing is not intended to limit the spirit, scope or intent of the invention. Consequently, the invention is intended to be limited only by the spirit and scope of the appended claims, giving full cognizance to equivalents in all respects.

What is claimed is:

1. A computer-implementable method for optimizing overall edge datacenter power and maintaining a compliant thermal state of edge devices comprising:
determining a thermal compliant policy of the edge devices in a cluster;
receiving telemetry attributes of the edge devices of the cluster;
applying a machine learning (ML) model using the telemetry to predict thermal condition of the edge devices over time; and
offloading workload from one edge device to another edge device if predicted thermal condition of one of the edge devices is not within the limits of the thermal compliant policy.

2. The method of claim 1, wherein the telemetry attributes include one or more of the following: CPU usage with a range of low, medium and high; memory usage with a range of low, medium and high; disk usage with a range of low, medium and high; network usage with a range of low, medium and high; power usage; and operating temperatures, inlet and outlet.

3. The method of claim 1, wherein the ML model is applied with a ML algorithm that includes include K-means clustering, support vector machine (SVM), K-nearest neighbors (KNN), stochastic gradient descent (SGD), logistic regression (LR), decision tree (DT), random forest (RF), and multi-layer perceptrons (MLP).

4. The method of claim 1, wherein edge devices are classified by one or more of a date time stamp, host name/unique ID, server class, workload type, CPU usage, memory usage, disk usage, network usage, power usage, inlet temperature, and outlet temperature.

5. The method of claim 1, wherein the telemetry attributes are normalized using min-max normalization.

6. The method of claim 1, wherein workloads are classified as short, medium, and long, based on duration.

7. The method of claim 1, wherein the offloading workload is based on either a lower limit or upper limit noncompliance.

8. A system comprising:
a processor;
a data bus coupled to the processor; and
a non-transitory, computer-readable storage medium embodying computer program code, the non-transitory, computer-readable storage medium being coupled to the data bus, the computer program code interacting with a plurality of computer operations for optimizing overall edge datacenter power and maintaining a compliant thermal state of edge devices executable by the processor and configured for:
determining a thermal compliant policy of the edge devices in a cluster;
receiving telemetry attributes of the edge devices of the cluster;
applying a machine learning (ML) model using the telemetry to predict thermal condition of the edge devices over time; and
offloading workload from one edge device to another edge device if predicted thermal condition of one of the edge devices is not within the limits of the thermal compliant policy.

9. The system of claim 8, wherein the telemetry attributes include one or more of the following: CPU usage with a range of low, medium and high; memory usage with a range of low, medium and high; disk usage with a range of low, medium and high; network usage with a range of low, medium and high; power usage; and operating temperatures, inlet and outlet.

10. The system of claim 8, wherein the ML model is applied with a ML algorithm that includes include K-means clustering, support vector machine (SVM), K-nearest neighbors (KNN), stochastic gradient descent (SGD), logistic regression (LR), decision tree (DT), random forest (RF), and multi-layer perceptrons (MLP).

11. The system of claim 8, wherein edge devices are classified by one or more of a date time stamp, host name/unique ID, server class, workload type, CPU usage, memory usage, disk usage, network usage, power usage, inlet temperature, and outlet temperature.

12. The system of claim 8, wherein the telemetry attributes are normalized using min-max normalization.

13. The system of claim 8, wherein workloads are classified as short, medium, and long, based on duration.

14. The system of claim 8, wherein the offloading workload is based on either a lower limit or upper limit noncompliance.

15. A non-transitory, computer-readable storage medium embodying computer program code for optimizing overall edge datacenter power and maintaining a compliant thermal state of edge devices, the computer program code comprising computer executable instructions configured for:
determining a thermal compliant policy of the edge devices in a cluster;
receiving telemetry attributes of the edge devices of the cluster;
applying a machine learning (ML) model using the telemetry to predict thermal condition of the edge devices over time; and
offloading workload from one edge device to another edge device if predicted thermal condition of one of the edge devices is not within the limits of the thermal compliant policy.

16. The non-transitory, computer-readable storage medium of claim 15, wherein the telemetry attributes include one or more of the following: CPU usage with a range of low, medium and high; memory usage with a range of low, medium and high; disk usage with a range of low, medium and high; network usage with a range of low, medium and high; power usage; and operating temperatures, inlet and outlet.

17. The non-transitory, computer-readable storage medium of claim 15, wherein the ML model is applied with a ML algorithm that includes include K-means clustering, support vector machine (SVM), K-nearest neighbors (KNN), stochastic gradient descent (SGD), logistic regression (LR), decision tree (DT), random forest (RF), and multi-layer perceptrons (MLP).

18. The non-transitory, computer-readable storage medium of claim 15, wherein edge devices are classified by one or more of a date time stamp, host name/unique ID, server class, workload type, CPU usage, memory usage, disk usage, network usage, power usage, inlet temperature, and outlet temperature.

19. The non-transitory, computer-readable storage medium of claim 15, wherein the telemetry attributes are normalized using min-max normalization.

20. The non-transitory, computer-readable storage medium of claim 15, wherein the offloading workload is based on either a lower limit or upper limit noncompliance.
